(19) United States
(12) Patent Application Publication
(10) Pub. No.: US 2014/0104221 A1
(43) Pub. Date: Apr. 17, 2014

(54) CAPACITIVE TOUCH PANEL SENSOR FOR MITIGATING EFFECTS OF A FLOATING CONDITION

(71) Applicant: Maxim Integrated Products, Inc., (US)

(72) Inventors: Guozhong Shen, San Jose, CA (US); Hongyu Li, Palo Alto, CA (US); Ronald Lee, San Francisco, CA (US); Xiaodan Mei, Fremont, CA (US)

(73) Assignee: MAXIM INTEGRATED PRODUCTS, INC., San Jose, CA (US)

(21) Appl. No.: 13/650,059

(22) Filed: Oct. 11, 2012

(51) Int. Cl. G06F 3/044; H01H 11/00

(52) U.S. Cl. 345/174; 29/622

(57) ABSTRACT

A capacitive touch panel includes elongated drive electrodes arranged next to one another and elongated sense electrodes arranged next to one another across the elongated drive electrodes. One or more of the elongated drive electrodes defines a notch along an edge of a drive electrode, where the notch is positioned between adjacent sense electrodes. In some embodiments, the drive electrode also defines a generally opposing notch on an opposing edge of the drive electrode. Additionally, one or more of the elongated sense electrodes can define an elongated aperture, and a second notch can be defined along the edge of the drive electrode proximate to the elongated aperture.

### BACKGROUND

A touch panel is a human machine interface (HMI) that allows an operator of an electronic device to provide input to the device using an instrument such as a finger, a stylus, and so forth. For example, the operator may use his or her finger to manipulate images on an electronic display, such as a display attached to a mobile computing device, a personal computer (PC), or a terminal connected to a network. In some cases, the operator may use two or more fingers simultaneously to provide unique commands, such as a zoom command, executed by moving two fingers away from one another; a shrink command, executed by moving two fingers toward one another; and so forth.

A touch screen is an electronic visual display that incorporates a touch panel overlying a display to detect the presence and/or location of a touch within the display area of the screen. Touch screens are common in devices such as all-in-one computers, tablet computers, satellite navigation devices, gaming devices, and smartphones. A touch screen enables an operator to interact directly with information that is displayed by the display underlying the touch panel, rather than indirectly with a pointer controlled by a mouse or touchpad. Capacitive touch panels are often used with touch screen devices. A capacitive touch panel generally includes an insulator, such as glass, coated with a transparent conductor, such as indium tin oxide (ITO). As the human body is also an electrical conductor, touching the surface of the panel results in a distortion of the panel's electric field, measurable as a change in capacitance.

### SUMMARY

A capacitive touch panel that uses patterns for drive and sense electrodes configured to minimize the effects of a floating point condition is disclosed. In one or more embodiments, the capacitive touch panel comprises elongated drive electrodes arranged next to one another and elongated sense electrodes arranged next to one another across the elongated drive electrodes. One or more of the elongated drive electrodes defines a notch along an edge of a drive electrode, where the notch is positioned between adjacent sense electrodes. In some embodiments, the drive electrode also defines a generally opposing notch on an opposing edge of the drive electrode. Additionally, one or more of the elongated sense electrodes can define an elongated aperture, and a second notch can be defined along the edge of the drive electrode proximate to the elongated aperture.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a diagrammatic illustration of a capacitive touch panel including single bar sense traces.

FIG. 2 is a diagrammatic illustration of a capacitive touch panel including double bar sense traces.

FIG. 3 is a diagrammatic illustration of a capacitive touch panel including triple bar sense traces.

FIG. 4 is a diagrammatic illustration of a capacitor formed at an intersection between a transmission electrode and a receiver electrode of a capacitive touch panel, where a touch is modeled under a grounded condition.

FIG. 5 is a diagrammatic illustration of a capacitor formed at an intersection between a transmission electrode and a receiver electrode of a capacitive touch panel, where a touch is modeled under a floating condition.

FIG. 6 is a top plan view illustrating drive and sense electrodes for a capacitive touch panel, where a drive electrode defines a notch positioned between adjacent sense electrodes along an edge of the drive electrode in accordance with an example embodiment of the present disclosure.

FIG. 7A is a top plan view illustrating drive and sense electrodes for a capacitive touch panel, where a drive electrode defines a notch positioned between adjacent sense electrodes along an edge of the drive electrode, a sense electrode defines an elongated aperture, and the drive electrode defines another notch along its edge proximate to the elongated aperture in accordance with an example embodiment of the present disclosure.

FIG. 7B is a top plan view illustrating drive and sense electrodes for a capacitive touch panel, where a drive electrode defines a notch positioned between adjacent sense electrodes along an edge of the drive electrode, and a sense electrode defines an elongated aperture in accordance with an example embodiment of the present disclosure.

FIG. 8A is a top plan view illustrating drive and sense electrodes for a capacitive touch panel, where a drive electrode defines a notch positioned between adjacent sense electrodes along an edge of the drive electrode, a sense electrode defines two elongated apertures, and the drive electrode defines additional notches along its edge proximate to the elongated apertures in accordance with an example embodiment of the present disclosure.

FIG. 8B is a top plan view illustrating drive and sense electrodes for a capacitive touch panel, where a drive electrode defines a notch positioned between adjacent sense electrodes along an edge of the drive electrode, and a sense electrode defines two elongated apertures in accordance with an example embodiment of the present disclosure.

FIG. 9 is a top plan view illustrating drive and sense electrodes for a capacitive touch panel, where a drive electrode defines a notch positioned between adjacent sense electrodes along an edge of the drive electrode, and the drive and sense electrodes are disposed on a single layer and connected together using jumpers in accordance with an example embodiment of the present disclosure.

FIG. 10 is an exploded isometric view illustrating a touch screen assembly incorporating a capacitive touch panel with drive and sense electrodes, where a drive electrode defines a notch positioned between adjacent sense electrodes along an edge of the drive electrode, and drive and sense layers are sandwiched between an LCD screen and a bonding layer with a protective cover attached thereto in accordance with an example embodiment of the present disclosure.

FIG. 11 is an exploded isometric view illustrating a touch screen assembly incorporating a capacitive touch panel with drive and sense electrodes, where a drive electrode defines a notch positioned between adjacent sense electrodes along an edge of the drive electrode, and a sense layer is disposed on a protective cover in accordance with an example embodiment of the present disclosure.

FIG. 12 is a flow diagram illustrating a method of furnishing a capacitive touch panel having one or more drive electrodes defining a notch along an edge of a drive electrode in accordance with an example embodiment of the present disclosure.

### DETAILED DESCRIPTION

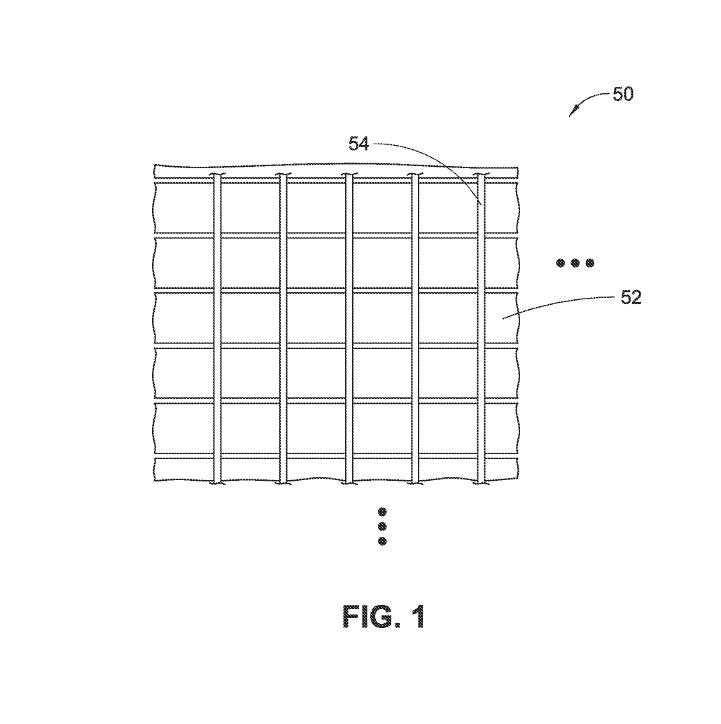

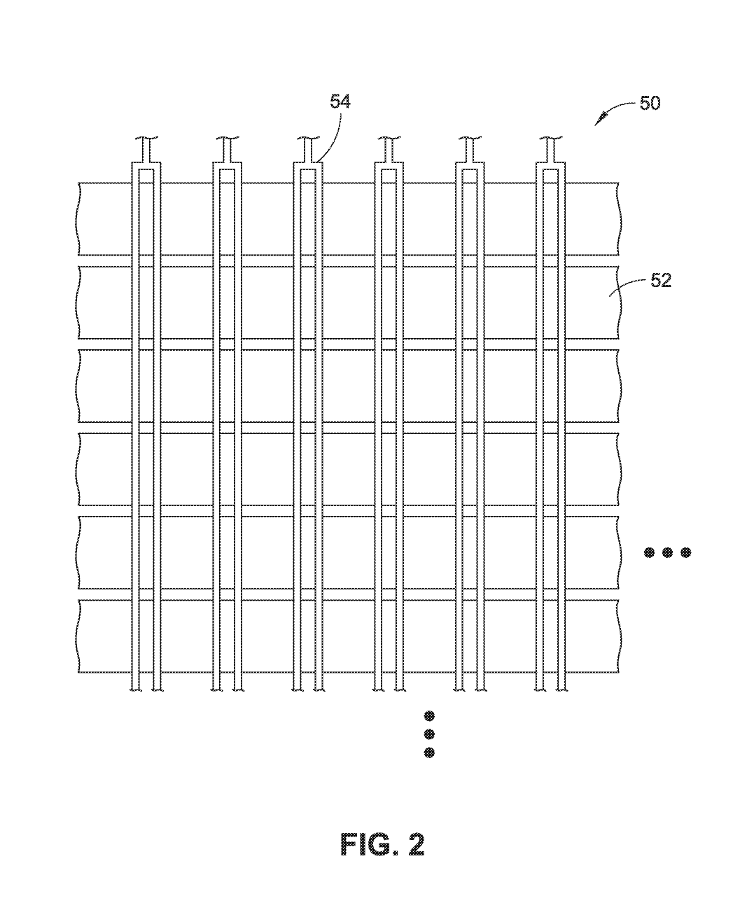

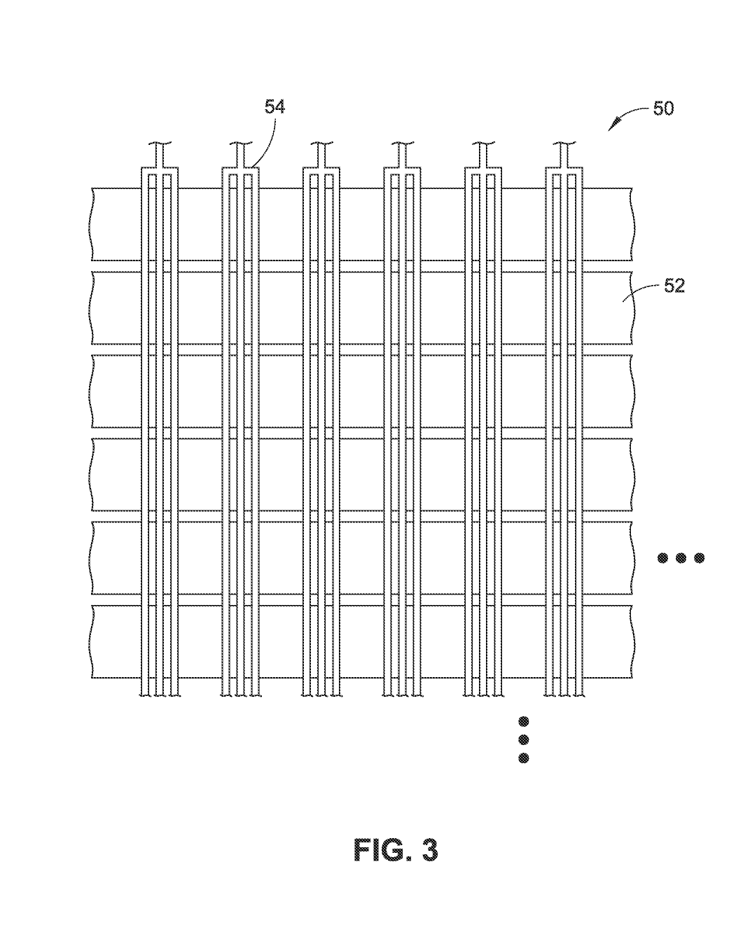

Referring generally to FIGS. 1 through 3, cross-bar X and Y ITO patterns can be used for transmission electrodes (e.g., drive traces 52) and receiver electrodes (e.g., sense traces 54) in mutual capacitance based capacitive touch panels 50. The drive and sense traces 52, 54 correspond to a coordinate system, where each coordinate location (pixel) comprises a capacitor formed at an intersection between a drive trace 52 and a sense trace 54. The drive traces 52 are connected to a current source to generate a local electric field at each capacitor, and a change in the local electric field generated by the touch of an instrument (e.g., a finger or a stylus) at each capacitor causes a change in capacitance at the corresponding coordinate location/pixel. As shown in FIG. 1, a sense trace 54 can comprise a single bar, where the single bar has a smaller width than the width of a drive trace 52. As shown in FIG. 2, a sense trace 54 can also comprise a double bar (e.g., two thin bars arranged side-by-side). As shown in FIG. 3, a sense trace 54 can further comprise a triple bar (e.g., three thin bars arranged side-by-side). In multiple bar configurations, the width of the bars can be reduced to maintain the overall width of a sense trace 54 (e.g., with respect to a single bar sense trace configuration).

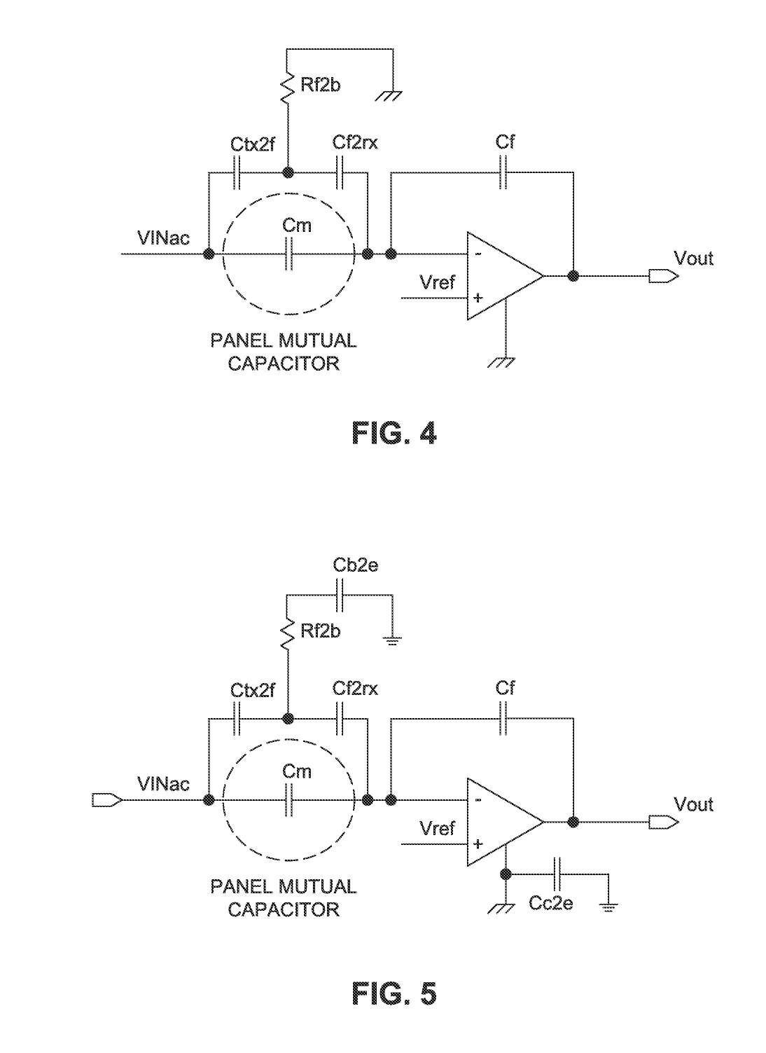

Referring generally to FIGS. 4 and 5, a touch at a capacitor formed at the intersection of a transmission electrode and a receiver electrode can be sensed when the mutual capacitance changes (e.g., decreases). In FIGS. 4 and 5, VINac represents a drive signal; Cm represents a mutual capacitance, which is reduced when a finger or stylus blocks electrical field lines from the transmission electrode to the receiver electrode; Ctx2f represents a capacitance between the transmission electrode and a finger or stylus; Rf2b represents a resistance between the finger or stylus and a human body; Cf2rx represents a capacitance between a finger and a receive channel; Cf represents feedback capacitor between negative input and output of the amplifier; Vref represents a reference voltage; and Vout represents an output signal. In FIG. 5, Cb2e represents a capacitance between the human body and an earth ground, and Cc2e represents a capacitance between the chassis of the capacitive touch panel and an earth ground. With reference to FIG. 4, a finger or stylus touch is modeled under a grounded condition. In an ideal case, Rf2b is equal to zero (0), and no signal is transmitted via Ctx2f. In this case, the circuit experiences only a mutual capacitance change and a touch of the finger or stylus is easily detected.

Referring now to FIG. 5, a finger or stylus touch is modeled under a floating condition (e.g., where a capacitive touch panel is not electrically connected to ground). This floating condition can occur when a human operator is using a capacitive touch panel. For example, the capacitive touch panel may be employed with an electronic device such as a smart phone, an internet tablet, and so forth. In such implementations, the electronic device may be situated on an insulated surface, such as a wooden table, rather than held by the operator. The operator may use the capacitive touch panel without physically holding the electronic device (e.g., when answering a phone using a single touch, and so forth). In these instances, a bridge path can be created from the transmission electrode to a finger or stylus and then to the receiver electrode, increasing the resulting signal and decreasing some portion of the mutual capacitance change that would otherwise be experienced during a grounded condition. In this manner, the signal change caused by a touch is reduced and possibly reversed. This condition can be exacerbated by a large finger when Ctx2f and Cf2rx increase, while delta Cm does not increase (e.g., when delta Cm is already saturated because the whole area has been covered above the pixel).

Bridge path effects can become more pronounced as the distance between traces and an operator's finger or stylus decreases. For instance, with touch panels having a thin panel stack-up (e.g., with cover glass having a thickness around one-half millimeter (0.50 mm) or smaller), the distance between capacitor electrodes and an operator's finger or stylus is reduced. Further, in some configurations, such as a sensor-on-lens implementation (e.g., one glass sensor (OGS), or glass +1 film (G1F) with a cover glass plus one (1) film layer), traces are positioned directly upon cover glass (e.g., opposite a touch surface), reducing the distance between the traces and a finger or stylus. As shown in FIG. 2, a double-bar capacitive touch panel can be used to increase mutual capacitance change while maintaining bridge effects at similar levels with respect to a single-bar sensor implementation. Further, as shown in FIG. 3, a triple-bar capacitive touch panel can be used to further increase mutual capacitance change while maintaining bridge effects at similar levels with respect to a single-bar sensor implementation.

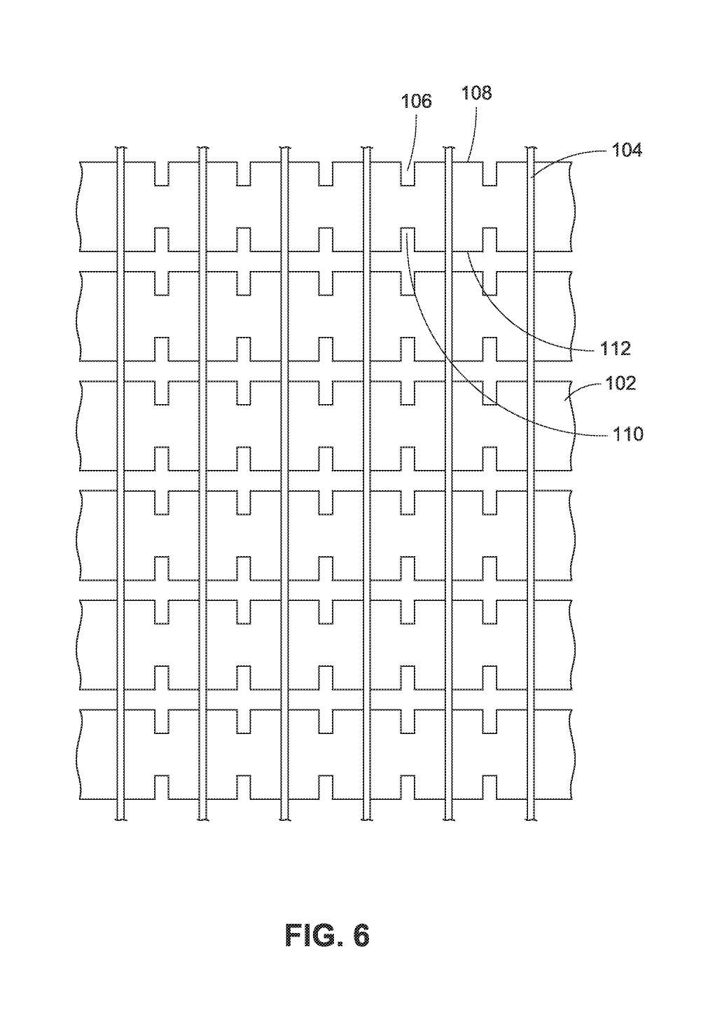

Referring generally to FIGS. 6 through 11, capacitive touch panels 100 are described that use patterns for drive and sense electrodes configured to minimize the effects of a floating point condition by reducing overlap between a finger or stylus and the drive electrodes. Embodiments of the disclosure can be used with capacitive touch panels having thin panel stack ups, and can improve touch performance for various sized instruments, including both large and small fingers. The capacitive touch panels 100 can be used to interface with electronic devices including, but not necessarily limited to: large touch panel products, all-in-one computers, mobile computing devices (e.g., hand-held portable computers, Personal Digital Assistants (PDAs), laptop computers, netbook computers, tablet computers, and so forth), mobile telephone devices (e.g., cellular telephones and smartphones), portable game devices, portable media players, multimedia devices, satellite navigation devices (e.g., Global Positioning System (GPS) navigation devices), e-book reader devices (eReaders), Smart Television (TV) devices, surface computing devices (e.g., table top computers), Personal Computer (PC) devices, as well as with other devices that employ touch-based human interfaces.

The capacitive touch panels 100 may comprise ITO touch panels that include drive electrodes 102, such as cross-bar ITO drive traces/tracks, arranged next to one another (e.g., along parallel tracks, generally parallel tracks, and so forth). In some embodiments, the drive electrodes 102 can be formed using highly conductive, optically transparent horizontal and/or vertical spines/bars. The drive electrodes 102 are elongated (e.g., extending along a longitudinal axis). For example, each drive electrode 102 may extend along an axis on a supporting surface, such as a substrate of a capacitive touch panel 100. The capacitive touch panels 100 also include sense electrodes 104, such as cross-bar ITO sense traces/tracks, arranged next to one another across the drive electrodes 102 (e.g., along parallel tracks, generally parallel tracks, and so forth). In some embodiments, the sense electrodes 104 can be formed using highly conductive, optically transparent vertical and/or horizontal spines/bars. The sense electrodes 104 are elongated (e.g., extending along a longitudinal axis). For instance, each sense electrode 104 may extend along an axis on a supporting surface, such as a substrate of a capacitive touch panel 100.

The drive electrodes 102 and the sense electrodes 104 define a coordinate system where each coordinate location (pixel) comprises a capacitor formed at each intersection between one of the drive electrodes 102 and one of the sense electrodes 104. Thus, the drive electrodes 102 are configured to be connected to an electrical current source for generating a local electric field at each capacitor, where a change in the local electric field generated by a finger and/or a stylus at each capacitor causes a decrease in capacitance associated with a touch at the corresponding coordinate location. In this manner, more than one touch can be sensed at differing coordinate locations simultaneously (or at least substantially simultaneously). In embodiments of the disclosure, the drive electrodes 102 can be driven by the electrical current source in parallel, e.g., where a set of different signals are provided to the drive electrodes 102. In other embodiments of the disclosure, the drive electrodes 102 can be driven by the electrical current source in series, e.g., where each drive electrode 102 or subset of drive electrodes 102 is driven one at a time.

One or more of the drive electrodes 102 defines a notch 106 along an edge 108 of the drive electrode 102, where the notch 106 is positioned between adjacent sense electrodes 104. In some embodiments, the drive electrode 102 also defines a generally opposing notch 110 on an opposing edge 112 of the drive electrode 102. The notches 106, 110 can be used to reduce capacitance coupled between a finger or stylus and a drive electrode 102 (e.g., as described by parameter Ctx2f in FIG. 5). In embodiments of the disclosure, notches can be formed in the drive electrodes 102 by selectively removing material to maintain shielding of the sense electrodes 104 from noise generated by other circuitry (e.g., noise from an underlying Liquid Crystal Display (LCD) screen, and so forth). Thus, notches in the drive electrodes 102 can be formed so that material is removed from areas adjacent to, but not immediately proximate to (e.g., under), the sense electrodes 104. The notches can be a variety of different shapes including, but not necessarily limited to: rectangle-shaped (e.g., square shaped), trapezoidal-shaped, rhombus-shaped, triangle-shaped, circular-shaped (e.g., semicircle-shaped), elliptical-shaped, diamond-shaped, and so forth.

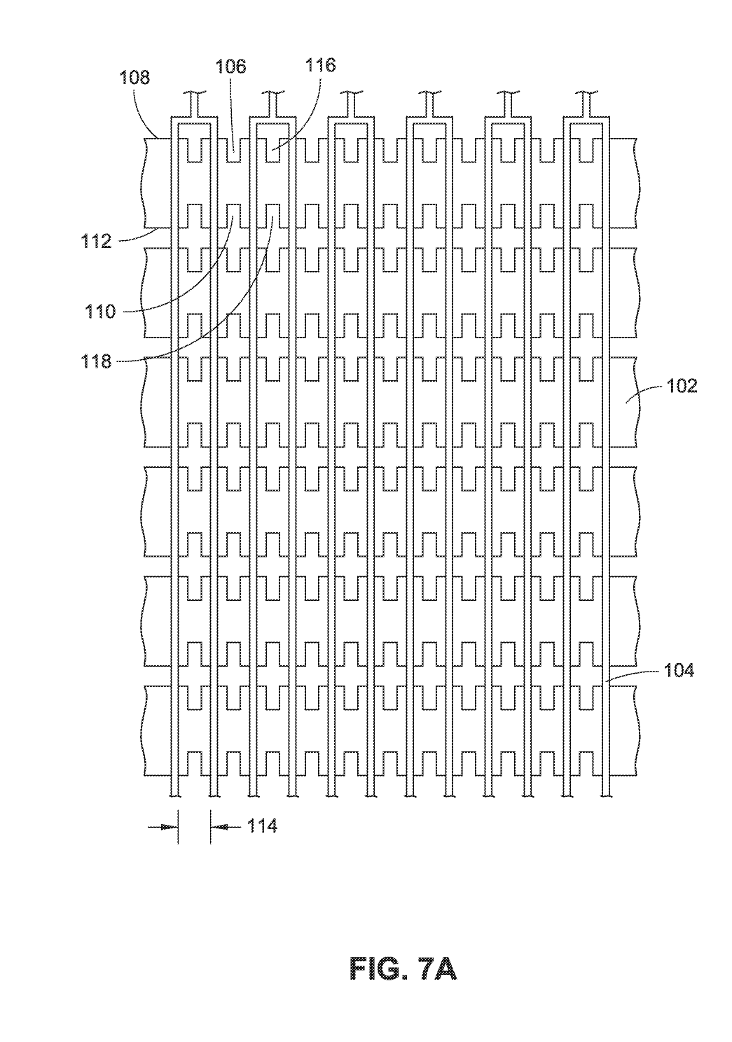

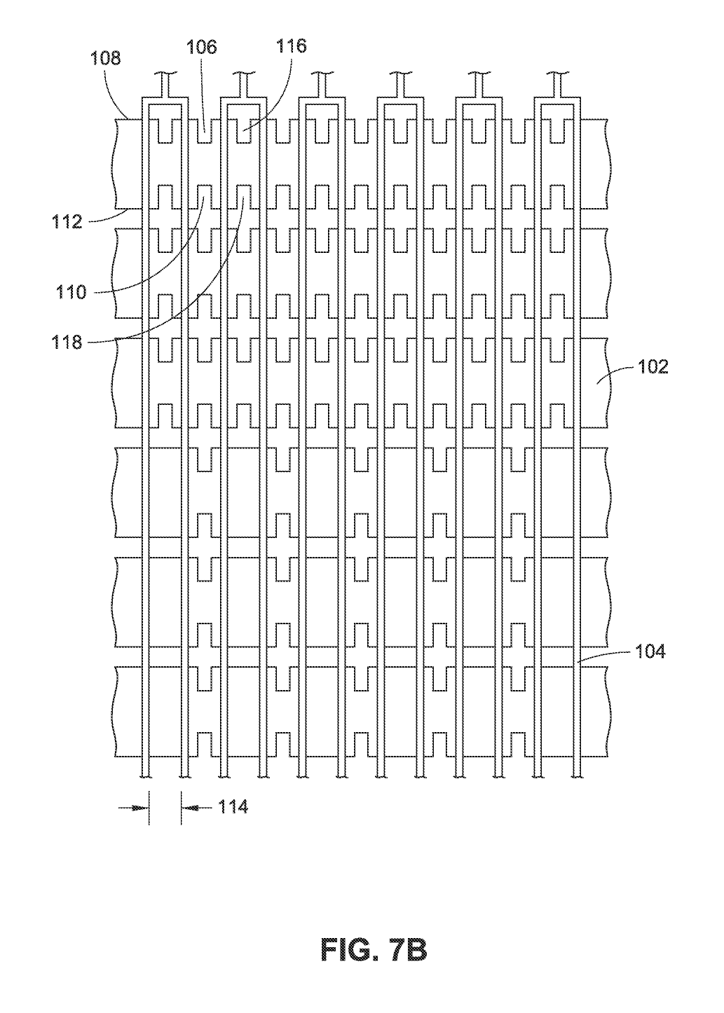

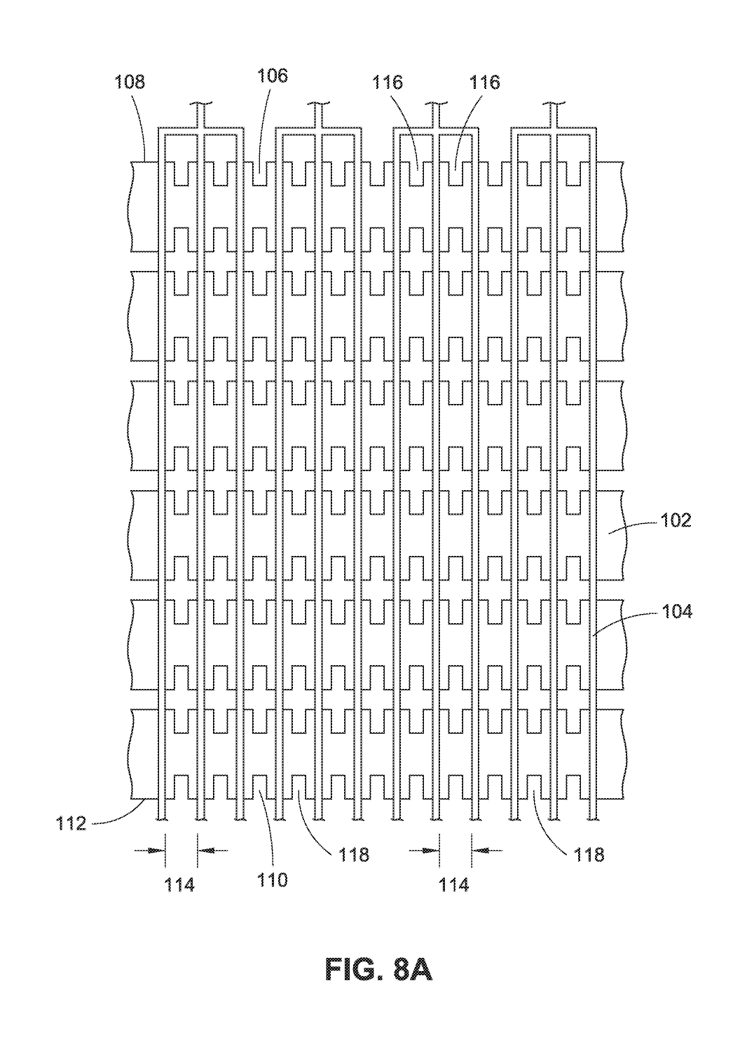

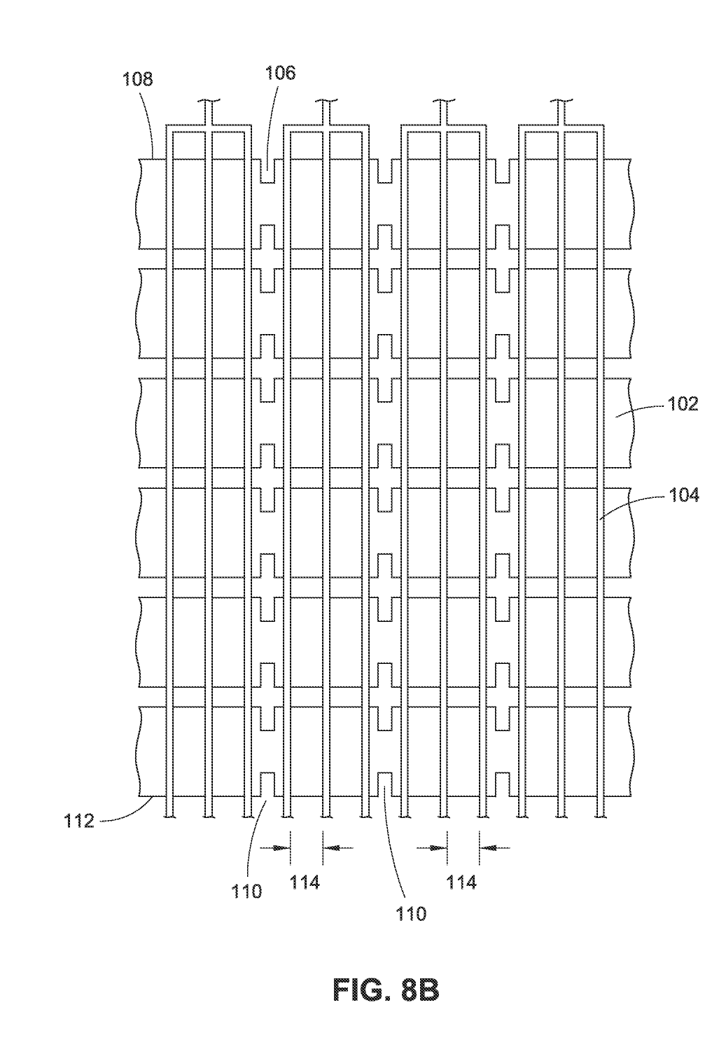

In some embodiments, one or more of the sense electrodes 104 can define one or more apertures configured to increase mutual capacitance change (e.g., in a double-bar capacitive touch panel configuration as shown in FIGS. 7A and 7B, a triple-bar capacitive touch panel configuration as shown in FIGS. 8A and 8B, and so forth). Additionally, one or more of the sense electrodes 104 can define an aperture (e.g., an elongated aperture 114), and a notch 116 can be defined along the edge 108 of the drive electrode 102 proximate to the elongated aperture 114. Further, a notch 118 can be defined along the opposing edge 112 of the drive electrode 102 proximate to the elongated aperture 114.

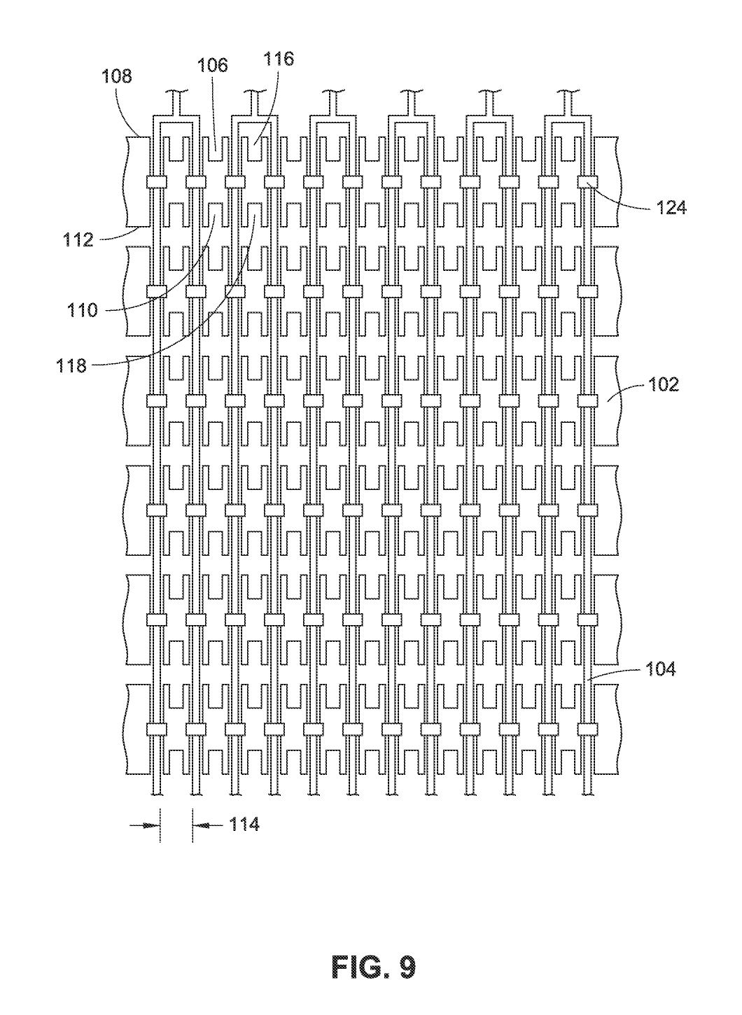

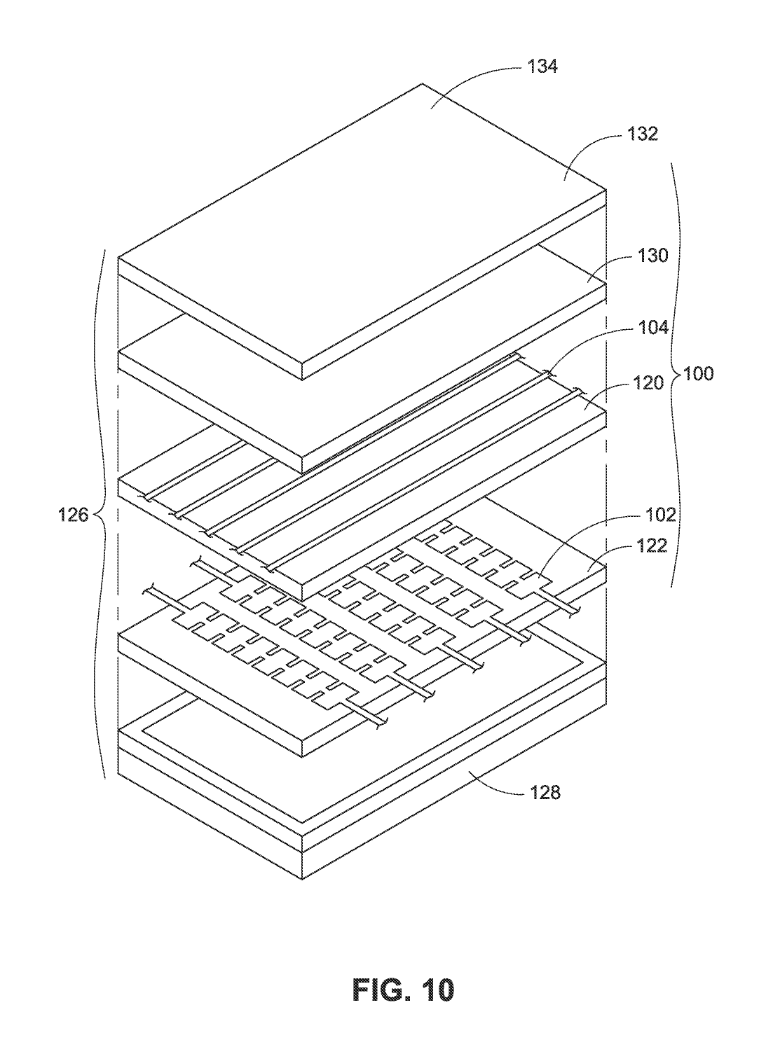

The sense electrodes 104 are electrically insulated from the drive electrodes 102 (e.g., using a dielectric layer, and so forth). For example, the sense electrodes 104 may be provided on one substrate (e.g., comprising a sense layer 120 disposed on a glass substrate), and the drive electrodes 102 may be provided on a separate substrate (e.g., comprising a drive layer 122 disposed on another substrate). In this two-layer configuration, the sense layer 120 can be disposed above the drive layer 122 (e.g., with respect to a touch surface). For example, the sense layer 120 can be positioned closer to a touch surface than the drive layer 122. However, this configuration is provided by way of example only and is not meant to be restrictive of the present disclosure. Thus, other configurations can be provided where the drive layer 122 is positioned closer to a touch surface than the sense layer 120, and/or where the sense layer 120 and the drive layer 122 comprise the same layer. For instance, in a 1.5-layer embodiment (e.g., where the drive layer 122 and the sense layer 120 are included on the same layer but physically separated from one another), one or more jumpers 124 can be used to connect portions of a drive electrode 102 together (e.g., as illustrated in FIG. 9). Similarly, jumpers can be used to connect portions of a sense electrode 104 together.

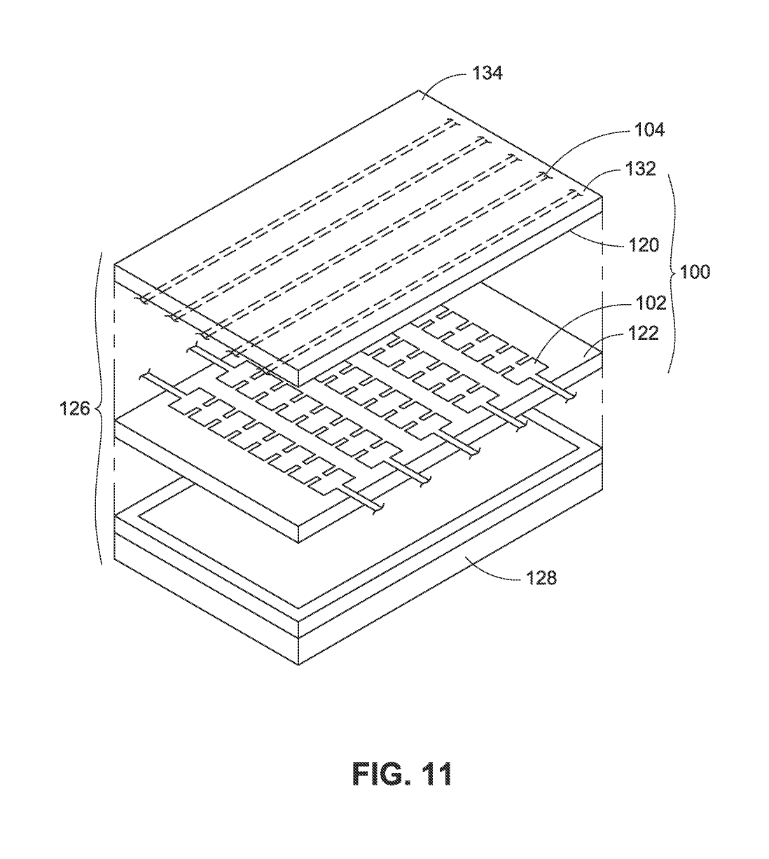

One or more capacitive touch panels 100 can be included with a touch screen assembly 126. The touch screen assembly 126 may include a display screen, such as an LCD screen 128, where the sense layer 120 and the drive layer 122 are sandwiched between the LCD screen 128 and a bonding layer 130, e.g., with a protective cover 132 (e.g., glass) attached thereto (e.g., as shown in FIG. 10). In other embodiments of the disclosure, a sensor-on-lens configuration can be used (e.g., one glass sensor (OGS), or glass +1 film (G1F) with a cover glass plus one (1) film layer), where the sense layer 120 and/or the drive layer 122 are positioned directly upon the protective cover 132 (e.g., as shown in FIG. 11). Further embodiments can be used in sensor-without-lens configurations. The protective cover 132 may include a protective coating, an anti-reflective coating, and so forth. The protective cover 132 may comprise a touch surface 134, upon which an operator can use one or more fingers, a stylus, and so forth to input commands to the touch screen assembly 126. The commands can be used to manipulate graphics displayed by, for example, the LCD screen 128. Further, the commands can be used as input to an electronic device connected to a capacitive touch panel 100, such as a multimedia device or another electronic device (e.g., as previously described).

Example Process

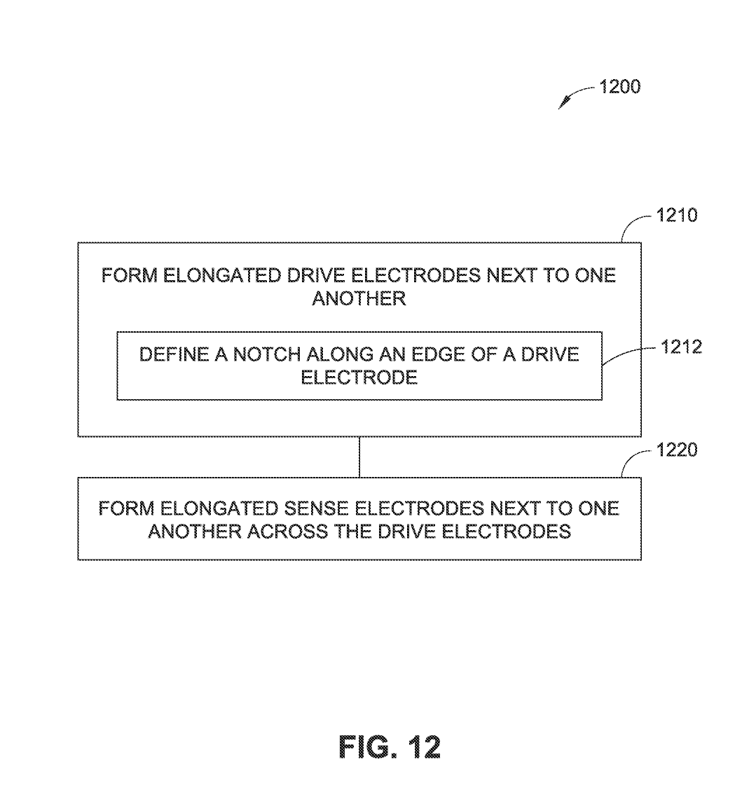

Referring now to FIG. 12, example techniques are described for furnishing capacitive touch panels having one or more drive electrodes defining a notch along an edge of a drive electrode.

FIG. 12 depicts a process 1200, in an example embodiment, for furnishing a capacitive touch panel, such as the capacitive touch panel 100 illustrated in FIGS. 6 through 11 and described above. In the process 1200 illustrated, elongated drive electrodes arranged next to one another are formed (Block 1210). For example, with reference to FIGS. 6 through 11, drive electrodes 102, such as cross-bar ITO drive traces/tracks, are arranged next to one another. The drive electrodes 102 can be formed on a substrate of a capacitive touch panel 100 using highly conductive, optically transparent horizontal and/or vertical bars. In embodiments of the disclosure, a drive electrode defines a notch along an edge of the drive electrode (Block 1212). For instance, with continuing reference to FIGS. 6 through 11, one or more of the drive electrodes 102 defines a notch 106 along an edge 108 of the drive electrode 102, where the notch 106 is positioned between adjacent sense electrodes 104. One or more of the drive electrodes 102 can also define a generally opposing notch 110 on an opposing edge 112 of the drive electrode 102.

Next, elongated sense electrodes arranged next to one another across the drive electrodes are formed (Block 1220). For example, with continuing reference to FIGS. 6 through 11, sense electrodes 104, such as cross-bar ITO sense traces/tracks, are arranged next to one another across drive electrodes 102. The sense electrodes 104 can be formed on a substrate of a capacitive touch panel 100 using highly conductive, optically transparent horizontal and/or vertical bars.

Conclusion

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A mutual capacitance projected capacitive touch panel comprising:
a plurality of elongated drive electrodes arranged next to one another and defining a notch along an edge of a drive electrode of the plurality of elongated drive electrodes; and
a plurality of elongated sense electrodes arranged next to one another across the plurality of elongated drive electrodes, the notch defined in the edge of the drive electrode of the plurality of elongated drive electrodes positioned between adjacent sense electrodes of the plurality of elongated sense electrodes.

2. The mutual capacitance projected capacitive touch panel as recited in claim 1, wherein the drive electrode of the plurality of elongated drive electrodes defines a generally opposing notch on an opposing edge of the drive electrode.

3. The mutual capacitance projected capacitive touch panel as recited in claim 1, wherein a sense electrode of the plurality of elongated sense electrodes defines an elongated aperture.

4. The mutual capacitance projected capacitive touch panel as recited in claim 3, wherein a second notch is defined along the edge of the drive electrode of the plurality of elongated drive electrodes proximate to the elongated aperture defined by the sense electrode.

5. The mutual capacitance projected capacitive touch panel as recited in claim 3, wherein a sense electrode of the plurality of elongated sense electrodes defines a second elongated aperture.

6. The mutual capacitance projected capacitive touch panel as recited in claim 5, wherein a second notch is defined along the edge of the drive electrode of the plurality of elongated drive electrodes proximate to at least one of the elongated aperture or the second elongated aperture defined by the sense electrode.

7. The mutual capacitance projected capacitive touch panel as recited in claim 1, wherein the plurality of elongated drive electrodes and the plurality of elongated sense electrodes are disposed on a single layer, and a plurality of jumpers is used to connect at least one of the plurality of drive electrodes or the plurality of sense electrodes.

8. A method of forming a mutual capacitance projected capacitive touch panel comprising:
forming a plurality of elongated drive electrodes arranged next to one another and defining a notch along an edge of a drive electrode of the plurality of elongated drive electrodes; and
forming a plurality of elongated sense electrodes arranged next to one another across the plurality of elongated drive electrodes, the notch defined in the edge of the drive electrode of the plurality of elongated drive electrodes positioned between adjacent sense electrodes of the plurality of elongated sense electrodes.

9. The method as recited in claim 8, wherein the drive electrode of the plurality of elongated drive electrodes defines a generally opposing notch on an opposing edge of the drive electrode.

10. The method as recited in claim 8, wherein a sense electrode of the plurality of elongated sense electrodes defines an elongated aperture.

11. The method as recited in claim 10, wherein a second notch is defined along the edge of the drive electrode of the plurality of elongated drive electrodes proximate to the elongated aperture defined by the sense electrode.

12. The method as recited in claim 10, wherein a sense electrode of the plurality of elongated sense electrodes defines a second elongated aperture.

13. The method as recited in claim 12, wherein a second notch is defined along the edge of the drive electrode of the plurality of elongated drive electrodes proximate to at least one of the elongated aperture or the second elongated aperture defined by the sense electrode.

14. The method as recited in claim 8, wherein the plurality of elongated drive electrodes and the plurality of elongated sense electrodes are disposed on a single layer, and the method further comprises connecting a plurality of jumpers to at least one of the plurality of drive electrodes or the plurality of sense electrodes.

15. A mutual capacitance projected capacitive touch panel comprising:
a plurality of elongated drive electrodes arranged next to one another and defining a notch along an edge of a drive electrode of the plurality of elongated drive electrodes and a generally opposing notch on an opposing edge of the drive electrode; and
a plurality of elongated sense electrodes arranged next to one another across the plurality of elongated drive electrodes, the notch defined in the edge of the drive electrode of the plurality of elongated drive electrodes positioned between adjacent sense electrodes of the plurality of elongated sense electrodes.

16. The mutual capacitance projected capacitive touch panel as recited in claim 15, wherein a sense electrode of the plurality of elongated sense electrodes defines an elongated aperture.

17. The mutual capacitance projected capacitive touch panel as recited in claim 16, wherein a second notch is defined along the edge of the drive electrode of the plurality of elongated drive electrodes proximate to the elongated aperture defined by the sense electrode.

18. The mutual capacitance projected capacitive touch panel as recited in claim 16, wherein a sense electrode of the plurality of elongated sense electrodes defines a second elongated aperture.

19. The mutual capacitance projected capacitive touch panel as recited in claim 18, wherein a second notch is defined along the edge of the drive electrode of the plurality of elongated drive electrodes proximate to at least one of the elongated aperture or the second elongated aperture defined by the sense electrode.

20. The mutual capacitance projected capacitive touch panel as recited in claim 15, wherein the plurality of elongated drive electrodes and the plurality of elongated sense electrodes are disposed on a single layer, and a plurality of jumpers is used to connect at least one of the plurality of drive electrodes or the plurality of sense electrodes.
